(19) United States
(12) Patent Application Publication
(10) Pub. No.: US 2004/0239189 A1
(43) Pub. Date: Dec. 2, 2004

(54) Electronic circuit

(76) Inventor: Lars Sundstrom, Lund (SE)

Correspondence Address: BURNS DOANE SWECKER & MATHIS L L P, POST OFFICE BOX 1404, ALEXANDRIA, VA, 22313-1404, US

(21) Appl. No.: 10/480,531

(22) PCT Filed: Jun. 19, 2002
(86) PCT No.: PCT/EP02/06788

Related U.S. Application Data
(60) Provisional application No. 60/301,126, filed on Jun. 28, 2001.

(30) Foreign Application Priority Data
Jun. 21, 2001 (GB) 0115221.4

(51) Int. Cl. H02M 1/00

(52) U.S. Cl. 307/32

(57) ABSTRACT

An electronic device has digital circuitry partitioned into digital circuit blocks, which are connected in series across a power supply, thereby sharing the available supply voltage between them. The device may be a battery-powered wireless communications device, including analog and digital circuitry, wherein the device includes a power supply, which provides a supply voltage which is supplied to the analog circuitry, and wherein the digital circuitry is separated into at least two blocks, which are connected in series across the power supply voltage.

### TECHNICAL FIELD OF THE INVENTION

This invention relates to electronic circuits, and in particular to digital circuits which can be operated at low supply voltages.

### BACKGROUND OF THE INVENTION

In many portable battery-powered devices, the power consumption is an important factor in the performance of the device. The document “Design techniques for low-power systems”, Havinga et al, Journal of Systems Architecture 46 (2000) 1-21 describes energy reduction techniques in the design of a portable hand-held computer and wireless communication system.

The total power consumption of digital electronic circuits depends to a large extent on the dynamic power consumption, namely the power which is used in carrying out switching operations. This dynamic power consumption, P, can be expressed as:

P=k.C.f.V_{SC}²

where k is a constant which depends on the amount of switching activity in the circuit, C is the equivalent switching capacitance of the circuit, f is the clock frequency, and V_{SC} is the circuit supply voltage.

Thus, one way of reducing the power consumption is to reduce the required supply voltage.

Improvements in manufacturing processes have resulted in reductions in the supply voltages which are needed by digital circuits, and these have led to reductions in power consumption.

However, many battery-powered devices also include analog circuitry, which often requires a higher supply voltage than the digital circuitry. As a result, the device must include a power source which provides a supply voltage which is considerably higher than the supply voltage required by the digital circuitry. When the available supply voltage is significantly higher than the supply voltage required by the digital circuitry, an additional device can be introduced in order to downconvert the available supply voltage to the required supply voltage.

The most commonly preferred form of additional device, which is used to downconvert an available supply voltage to a lower required supply voltage, is a switched DC-DC converter (SDCC). However, the use of a switched DC-DC converter does have some disadvantages. Firstly, of course, although these devices are more efficient than the more common alternatives, they typically operate with an efficiency of 80-90%, which means that some of the theoretically available power saving cannot be achieved in practice. Secondly, the switching that occurs in a SDCC generates spurious signals, which can in some cases interfere with the signals which are present in the analog circuitry of a wireless communications device. Thirdly, the SDCC requires additional components, which increase the cost of the device, as well as increasing the space requirements for the device.

### SUMMARY OF THE INVENTION

According to a first aspect of the present invention, there is provided an electronic device, in which digital circuit blocks are connected in series across a power supply, thereby sharing the available supply voltage between them.

In a preferred embodiment of the invention, there is provided a battery-powered wireless communications device, including analog and digital circuitry, wherein the device includes a power supply which provides a supply voltage which is supplied to the analog circuitry, and wherein the digital circuitry is separated into at least two blocks, which are connected in series across the power supply voltage.

It should be emphasised that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

FIG. 1 is a block schematic diagram of an electronic device embodying the present invention.

FIG. 2 is a block schematic diagram of a second electronic device embodying the present invention.

FIG. 3 is a block schematic diagram of a part of an electronic device according to the present invention.

FIG. 4 is a block schematic diagram of another part of an electronic device according to the present invention.

FIG. 5 is a block schematic diagram of another part of an electronic device according to the present invention.

FIG. 6 is a block schematic diagram of another part of an electronic device according to the present invention.

FIG. 7 is a block schematic diagram of another part of an electronic device according to the present invention.

FIG. 8 is a block schematic diagram of another part of an electronic device according to the present invention.

FIG. 9 is a block schematic diagram of another part of an electronic device according to the present invention.

FIG. 10 is a block schematic diagram of another part of an electronic device according to the present invention.

FIG. 11 is a block schematic diagram of another part of an electronic device according to the present invention.

FIG. 12 is a block schematic diagram of another part of an electronic device according to the present invention.

FIG. 13 is a block schematic diagram of another part of an electronic device according to the present invention.

FIG. 14 is a block schematic diagram of another part of an electronic device according to the present invention.

FIG. 15 is a block schematic diagram of another part of an electronic device according to the present invention.

FIG. 16 is a block schematic diagram of another part of an electronic device according to the present invention.

FIG. 17 is a block schematic diagram of an electronic circuit in accordance with the present invention.

FIG. 18 is a block schematic diagram of a part of an electronic device according to the present invention.

FIG. 19 is a block schematic diagram of another part of an electronic device according to the present invention.

FIG. 20 is a block schematic diagram of another part of an electronic device according to the present invention.

FIG. 21 is a block schematic diagram of another part of an electronic device according to the present invention.

FIG. 22 is a block schematic diagram of another electronic circuit in accordance with the present invention.

### DETAILED DESCRIPTION OF PREFERRED EMBODIMENTS

The present invention is generally applicable to electronic devices, and is of particular applicability to devices where power consumption is a major consideration, especially battery-powered devices, such as portable wireless communication devices or portable computing devices, such as mobile radio terminals (including mobile telephones, pagers and communicators), electronic organisers, smartphones, personal digital assistants (PDAs), or the like.

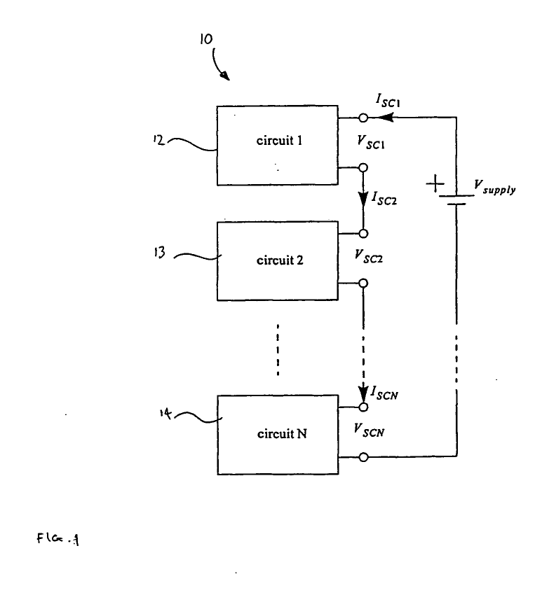

FIG. 1 is a block schematic diagram of an electronic device 10, showing the principle behind the present invention.

The device has a battery power supply, providing a specified supply voltage V_{supply}. The device 10 includes digital circuitry which, in this illustrated embodiment, is partitioned into a number N of digital circuit blocks 12, 13, 14.

As shown in FIG. 1, the circuit blocks 12, 13, 14 are connected in series across the supply voltage. For each of the circuit blocks, the current consumption depends on the operation of the block. Thus, for the Nth circuit block 14, the current consumption I_{SCN} is given by:

I_{SCN}=K_{N}f_{N}.V_{SCN}

where K_{N} is a constant which depends on the degree of activity in the circuit block and the equivalent switching capacitance, f_{N} is the clock frequency in that circuit block, and V_{SCN} is the supply voltage for that circuit block.

It is apparent from FIG. 1 that the current supplied to each of the circuit blocks is equal, and hence that the voltage supply to each of the current blocks is a fraction of the available supply voltage V_{supply} with the size of the fraction in each case depending on the value of the product K_{N}.f_{N}.

In the case where there are two circuit blocks, the current consumptions I_{SC1} and I_{SC2} in each block are given by:

I_{SC1}=K₁.f₁.V_{SC1}

and:

I_{SC2}=K₂.f₂.V_{SC2}

Since the same current is flowing in the two circuit blocks, that is, I_{SC1}=I_{SC2}, and since:

V_{supply}=V_{SC1}+V_{SC2},

then the voltages applied across the two circuit blocks are given by:

$$\begin{matrix}{V}_{SC2} = {V}_{supply} \cdot \frac{{K}_{1} {f}_{1}}{{K}_{1} {f}_{1} + {K}_{2} {f}_{2}} \\ and \text{:} \\ {V}_{SC1} = {V}_{supply} \cdot \frac{{K}_{2} {f}_{2}}{{K}_{1} {f}_{1} + {K}_{2} {f}_{2}}\end{matrix}$$

It will be apparent that this analysis can be extended to arrangements in which the circuitry is partitioned into any number of blocks.

Thus, provided that the digital circuitry can be partitioned into circuit blocks which consume the same amount of current, and provided that the supply voltages required by those blocks can then be obtained by dividing up the available supply voltage V_{supply} as described above, the circuit of FIG. 1 can efficiently provide the required supply voltages to those blocks.

It should be noted that any change in activity in any one of the circuit blocks will cause a change in the voltages applied to all of the circuit blocks, and a change in the current flowing through each of the blocks.

It will also be apparent to the person skilled in the art that, although this analysis concentrates on the power consumption caused by switching activity in the digital circuit blocks, some digital circuitry has a significant static power consumption, and the analysis can be extended to take account of the resultant effect on the current and voltage supplies.

It will be noted that any variations in the power consumption of a circuit block will have an effect on the voltage supplied not only to that block, but also to the other circuit blocks. Such variations may arise, for example, because of changes in the switching activity in a block.

For some digital circuits, such as digital signal processors, the variation in power consumption due to changes in the switching activity are typically small. However, if there is any variation which produces unacceptably large variations in the current consumption of a circuit block, and hence in the voltage supplied to that or any other circuit block, or if it is not possible to partition the circuitry to provide the required supply voltages, supply correction circuits can be included.

FIG. 2 is a block schematic diagram of an electronic device 20, showing the general case where the digital circuitry is partitioned into a number N of circuit blocks 21, 22, 23. The device also has a battery power supply, providing a specified supply voltage V_{supply}. Each of the circuit blocks 21, 22, 23 has a respective serial supply correction circuit (SSCC) 24, 25, 26 connected in series with it, and a respective parallel supply correction circuit (PSCC) 27, 28, 29 connected in parallel with it.

It will be appreciated that, in any specific case, a digital circuit block may have only a serial supply correction circuit (SSCC), or only a parallel supply correction circuit (PSCC), or neither, associated with it.

Again in general terms, the serial supply correction circuits can be designed to add or subtract voltages, while the parallel supply correction circuits can be designed to add or subtract correction currents I_{corr}, in order to obtain the desired supply voltages and currents in the different circuit blocks.

Some examples of supply correction circuits will now be described with reference to the following figures.

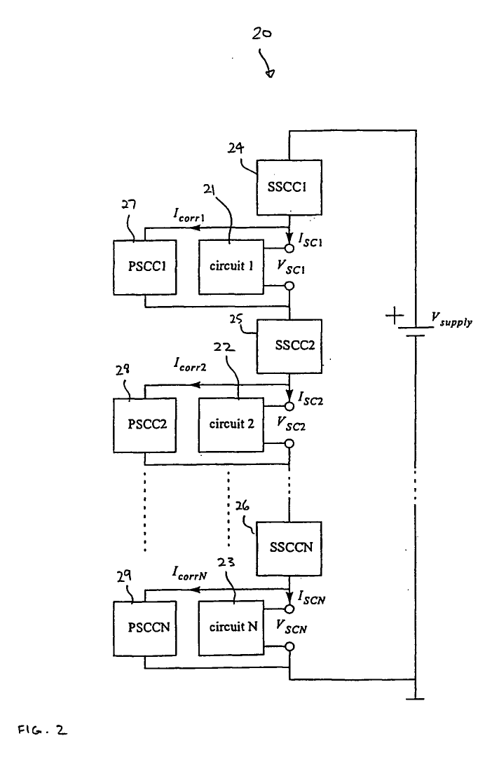

FIG. 3 shows a circuit block 31, having a parallel supply correction circuit 32 connected in parallel with it. In this case, the parallel supply correction circuit 32 comprises a capacitor C_{cor}, the size of which can be chosen such that it can average short term variations in the supply.

The use of a parallel capacitor as a supply correction circuit is similar in some ways to the conventional use of a decoupling capacitor to smooth variations in voltage supply. However, in that conventional case, the decoupling capacitor is effectively in parallel with all of the circuit blocks, since each circuit block receives the available supply voltage. In this situation, by contrast, the circuit blocks are connected in series, and the parallel capacitor is used to stabilise the voltage supply in the presence of changes in the current consumption.

FIG. 4 shows a circuit block 41, having a series supply correction circuit 42 connected in series with it. In this case, the series supply correction circuit 42 comprises an inductor L_{cor}, the size of which can again be chosen such that it can average short term variations in the supply.

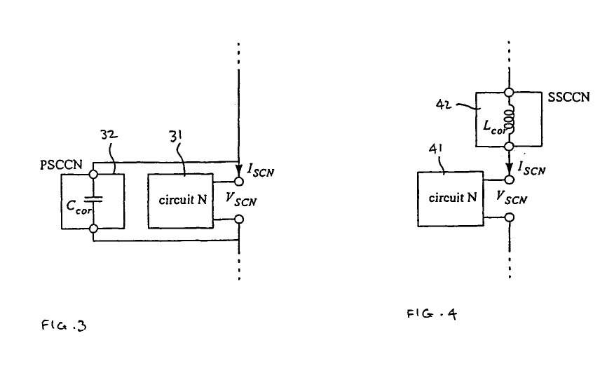

FIG. 5 shows a circuit block 51, having a parallel supply correction circuit 52 connected in parallel with it. In this case, the parallel supply correction circuit 52 comprises a current source, chosen such that it can draw current in parallel with the block 51, in order to lower the voltage supplied to the block 51.

FIG. 6 shows a circuit block 61, having a parallel supply correction circuit 62 connected in parallel with it. In this case, the parallel supply correction circuit 62 comprises a current source, chosen such that it can add current in parallel with the block 61, in order to increase the voltage supplied to that block.

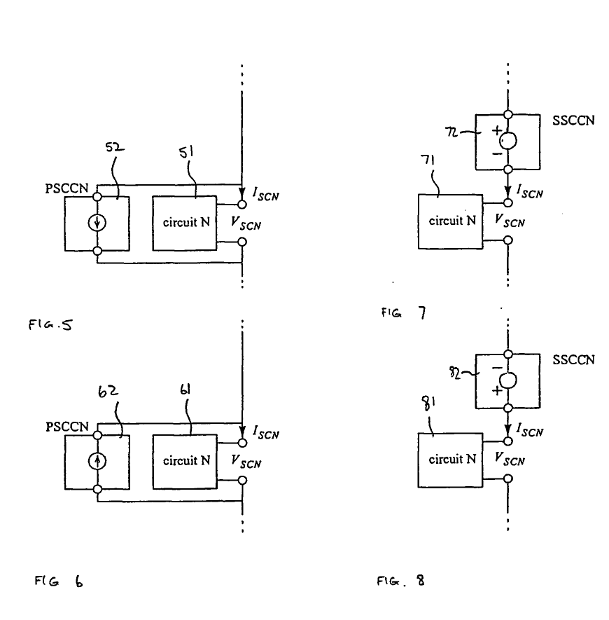

FIG. 7 shows a circuit block 71, having a series supply correction circuit 72 connected in series with it. In this case, the series supply correction circuit 72 comprises a voltage source, connected to have a specific voltage connected across it, in order to lower the voltage supplied to the block 71.

FIG. 8 shows a circuit block 81, having a series supply correction circuit 82 connected in series with it. In this case, the series supply correction circuit 82 comprises a voltage source, connected to add a specific voltage, in order to increase the voltage supplied to the block 81.

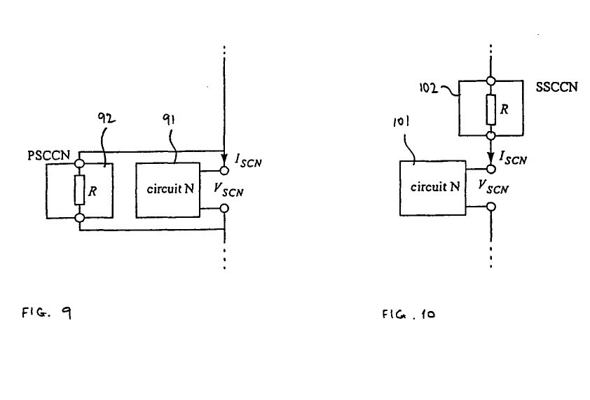

FIG. 9 shows a more specific case of the arrangement of FIG. 5, with a circuit block 91, having a parallel supply correction circuit 92 connected in parallel with it. In this case, the parallel supply correction circuit 92 comprises a current sink in the form of a resistor R. Provided that the error to be corrected is small and static, the resistor R can be used to draw the required current without significant disadvantage in terms of the overall power consumption.

FIG. 10 shows a more specific case of the arrangement of FIG. 7, with a circuit block 101, having a series supply correction circuit 102 connected in series with it. In this case, the series supply correction circuit 102 comprises a resistor R, which has the required voltage drop across it. Again, provided that the error to be corrected is small and static, the resistor R can be used without significant disadvantage in terms of the overall power consumption.

FIG. 11 shows another variant of the arrangement of FIG. 5, with a circuit block 111, having a parallel supply correction circuit 112 connected in parallel with it. In this case, the parallel supply correction circuit 112 comprises a dummy circuit (DUC), that is, a digital circuit which may or may not have another function in the circuit, but which has a dynamic power consumption which matches that of the circuit block 111, in order to draw a current which means that the voltage and current supplied to the circuit block ill are as required.

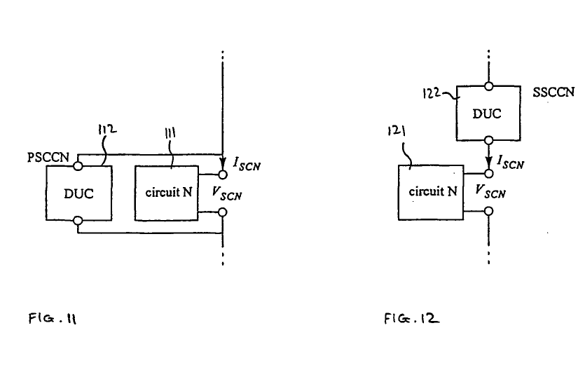

FIG. 12 shows another variant of the arrangement of FIG. 7, with a circuit block 121, having a series supply correction circuit 122 connected in series with it. Again, in this case, the series supply correction circuit 122 comprises a dummy circuit (DUC), that is, a digital circuit which may or may not have another function in the circuit, but which has a dynamic power consumption which matches that of the circuit block 121, in order to draw a supply voltage which means that the voltage and current supplied to the circuit block 121 are as required.

In the case of FIG. 11 and FIG. 12, the dummy digital circuits 112, 122 can be controlled for example by changing the degree of activity in the circuit, that is by turning parts of the circuit on or off. As another example, a clock frequency in a dummy digital circuit can be altered in a way which is determined directly by the magnitude of the voltage change which the dummy circuit is intended to compensate. Changing the clock frequency has the advantage that a single control signal can be used to change the clock frequency and hence affect the power consumption in the dummy digital circuits, as discussed previously.

The arrangements shown in FIGS. 5-12 are generally acceptable when the partitioning of the digital circuitry into circuit blocks results in errors which are small enough to be compensated as described above, without introducing excessive additional components or causing an unacceptable increase in the power consumption.

However, when these errors cannot easily be compensated, it is preferable to choose a method of partitioning of the digital circuitry into circuit blocks which does not cause these problems.

If this is not possible, the supply correction circuits can preferably take the form of high efficiency switched DC-DC converters (SDCCs). Switched DC-DC converters can either downconvert or upconvert a given voltage to another desired voltage, and for example can recycle power back to the supply.

The use of switched DC-DC converters (SDCCs) can be particularly useful when one or more of the circuit blocks can be switched off entirely for some part of the time, in order to reduce power consumption. In that case, the use of a supply correction circuit in the form of a switched DC-DC converter can be the most efficient way of maintaining the voltages and currents supplied to the other circuit blocks at their intended levels.

Thus, FIG. 13 shows a circuit block 131, having a parallel supply correction circuit 132 connected in parallel with it. In this case, the parallel supply correction circuit 132 comprises a switched DC-DC converter (SDCC), which can recycle to the main supply any power which it consumes.

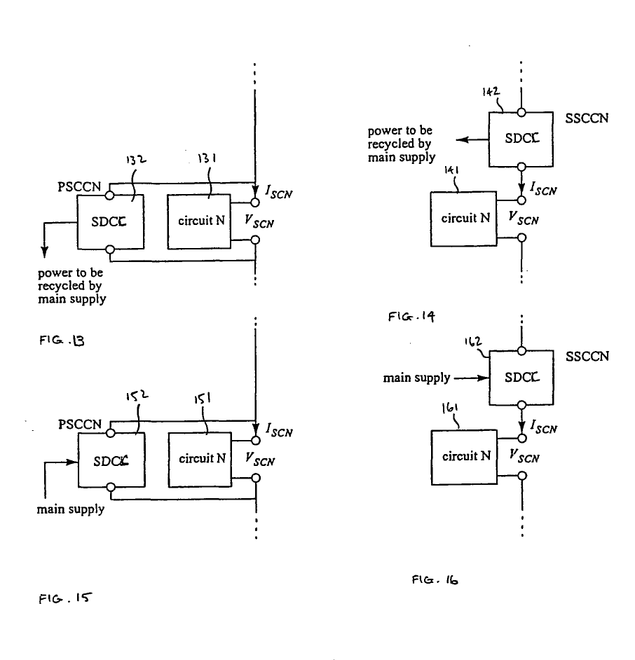

FIG. 14 shows a circuit block 141, having a series supply correction circuit 142 connected in series with it. Again, in this case, the series supply correction circuit 142 comprises a switched DC-DC converter (SDCC), which can recycle to the main supply any power which it consumes.

FIG. 15 shows a circuit block 151, having a parallel supply correction circuit 152 connected in parallel with it. In this case, the parallel supply correction circuit 152 comprises a switched DC-DC converter (SDCC), which can receive power from the main supply and thus act as a current supply.

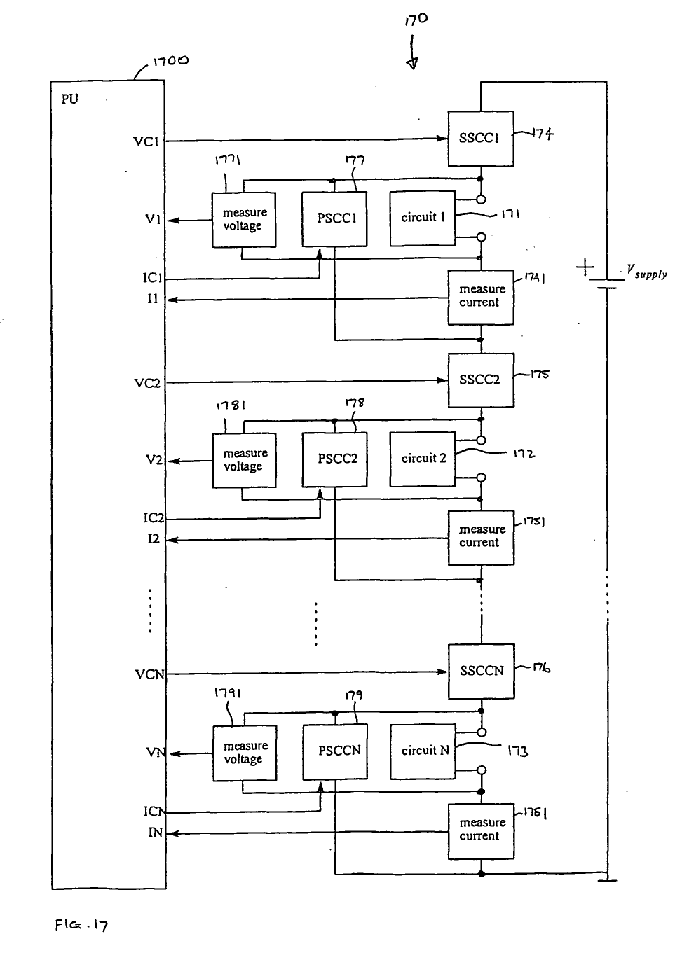

FIG. 16 shows a circuit block 161, having a series supply correction circuit 162 connected in series with it. Again, in this case, the series supply correction circuit 162 comprises a switched DC-DC converter (SDCC), which can receive power from the main supply and thus act as a voltage source.

Although the devices shown in FIGS. 13-16 include switched DC-DC converters (SDCCs)., it will be noted that these SDCCs are operating at much lower power levels than would be required by an SDCC which was downconverting a power supply voltage to a voltage supply for digital circuitry in the conventional way. As a result, the problems of component size and interference with analog circuitry will similarly be greatly reduced.

The Figures described above include supply correction circuits which can be designed to handle expected changes in the power consumption of circuit blocks. However, in some cases, the changes in power consumption will be too large, or too unpredictable, to be handled in this way. In such circumstances, the changes in power consumption can advantageously be handled, in accordance with the invention, by adjustable supply correction circuits.

FIG. 17 is a block schematic diagram of an electronic device 170, showing the general case where the digital circuitry is partitioned into a number N of circuit blocks 171, 172, 173. The device also has a battery power supply, providing a specified supply voltage V_{supply}. Each of the circuit blocks 171, 172, 173 has a respective serial supply correction circuit (SSCC) 174, 175, 176 connected in series with it, and a respective parallel supply correction circuit (PSCC) 177, 178, 179 connected in parallel with it.

It will be appreciated that, in any specific case, a digital circuit block may have only a serial supply correction circuit (SSCC), or only a parallel supply correction circuit (PSCC), or neither, associated with it.

Again in general terms, the serial supply correction circuits can be designed to add or subtract voltages, while the parallel supply correction circuits can be designed to add or subtract correction currents, in order to obtain the desired supply voltages and currents in the different circuit blocks.

In this circuit, however, the serial supply correction circuits 174, 175, 176 and the parallel supply correction circuits 177, 178, 179 are adjustable. That is, each of the circuit blocks 171, 172, 173 also has a respective current measuring circuit 1741, 1751, 1761 connected in series with it, and a respective voltage measuring circuit 1771, 1781, 1791 connected in parallel with it.

Each of the measured values I1, I2, IN obtained from the current measuring circuits 1741, 1751, 1761, and the measured values V1, V2, VN obtained from the voltage measuring circuits 1771, 1781, 1791 is supplied to a processing unit 1700. On the basis of these measured values, the processing unit 1700 supplies respective control signals VC1, VC2, VCN to the serial supply correction circuits 174, 175, 176, and respective control signals IC1, IC2, ICN to the parallel supply correction circuits 177, 178, 179.

The processing unit 1700 could be implemented using a microprocessor, which is software controlled to adjust the control signals on the basis of the measured current and voltage values, in order that the supply correction circuits compensate appropriately for any changes in consumption. Alternatively, the processing unit 1700 could be a set of feedback loops which provide appropriate control of the supply correction circuits.

It will be appreciated that, in any specific case, the external control of the supply correction circuits described here may be applied only to a subset of the serial supply correction circuits and/or only to a subset of the parallel supply correction circuits.

FIG. 18 shows a circuit block 181, having an adjustable parallel supply correction circuit 182 connected in parallel with it. In this case, the adjustable parallel supply correction circuit 182 comprises a MOSFET transistor, which can be controlled by a control signal ICN to draw a desired current through the transistor, and hence away from the circuit block 181.

FIG. 19 shows a circuit block 191, having an adjustable series supply correction circuit 192 connected in series with it. In this case, the adjustable series supply correction circuit 192 comprises a MOSFET transistor, which can be controlled by a control signal VCN such that it has a desired voltage across the transistor, thereby producing the required voltage drop across the circuit block 191.

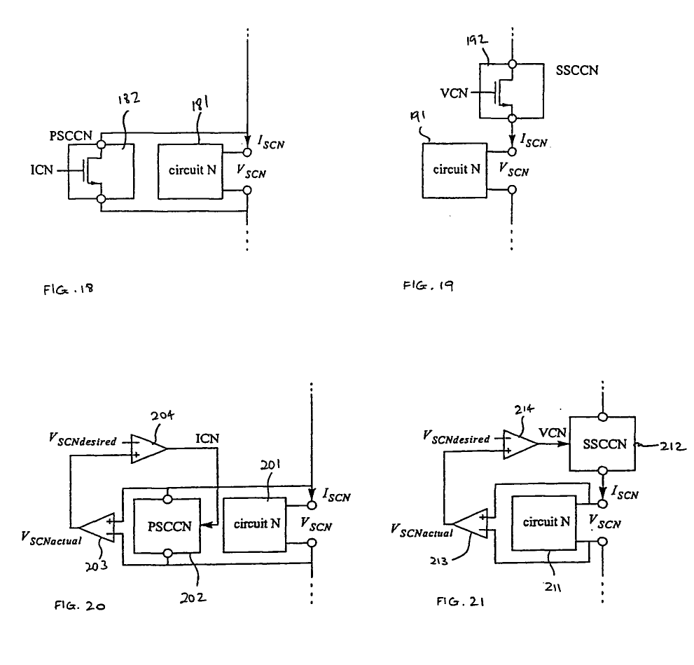

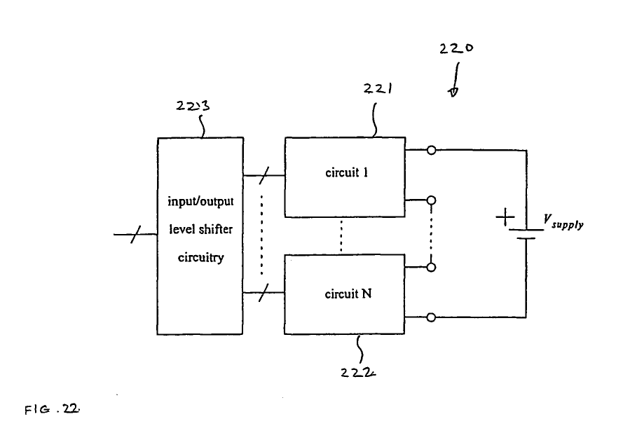

FIGS. 20 and 21 show circuits similar to those illustrated in FIGS. 18 and 19 respectively, showing how the desired supply voltage levels may be maintained.

Thus, FIG. 20 shows a circuit block 201, having an adjustable parallel supply correction circuit (PSCC) 202 connected in parallel with it. On the assumption that the current consumed by the PSCC has a monotonically increasing relationship with a control signal ICN, the control circuit can include a differential amplifier 203 with unity gain, which measures the voltage drop across the circuit 201 V_{SCNactual} and supplies the result as an input to a second differential amplifier 204, which receives the desired value of the voltage drop, V_{SCNdesired}, as its other input. The output of the second differential amplifier 204 is then a control signal ICN, which acts as the error signal in a feedback loop, and causes the PSCC 202 to draw a desired current. The gain of the amplifier 204 can be set to a desired value so that the desired voltage drop across the circuit 201 is achieved with sufficient accuracy, while satisfying conventional requirements for feedback loops, such as stability.

FIG. 21 shows a circuit block 211, having an adjustable series supply correction circuit 212 (SSCC) connected in series with it. On the assumption that the voltage across the SSCC has a monotonically increasing relationship with a control signal VCN, the control circuit can include a differential amplifier 213 with unity gain, which measures the voltage drop V_{SCNactual} across the circuit 211 and supplies the result as an input to a second differential amplifier 214, which receives the desired value of the voltage drop, V_{SCNdesired}, as its other input. The output of the second differential amplifier 214 is then a control signal VCN, which acts as the error signal in a feedback loop, and causes the SSCC 212 to draw a desired current. The gain of the amplifier 214 can be set to a desired value so that the desired voltage drop across the circuit 211 is achieved with sufficient accuracy, while satisfying conventional requirements for feedback loops, such as stability.

One result of connecting the digital circuit blocks in series across the available power supply, in accordance with the invention, is that the circuit blocks receive a power supply voltage that is not tied to ground. For example, in the case of two digital circuit blocks, each requiring a 1.5V supply, with an available 3V battery power supply, one of the circuit blocks will be connected between 0V and 1.5V, as is conventional, but the other will be connected between 1.5V and 3V.

The result is that, in the absence of other measures, the circuit blocks would be unable to communicate with each other, or with other parts of the circuitry, because the input and output signals of the blocks would not be at the appropriate levels.

In order to handle this situation, level shifting circuitry can be used where it is required.

FIG. 22 is a schematic block diagram of an electronic device 220, showing the general case where the digital circuitry is partitioned into a number N of circuit blocks 221, 222. The device also has a battery power supply, providing a specified supply voltage V_{supply}. Some or all of the circuit blocks 221, 222, may have respective serial supply correction circuits (not shown) connected in series with them, and or respective parallel supply correction circuit (not shown) connected in parallel with them.

Each of the digital circuit blocks 221, 222 is connected to level shifter circuitry 223, which ensures that input signals supplied to the digital circuit blocks and output signals supplied from the digital circuit blocks, are supplied at the correct signal levels.

The digital circuit blocks, into which the digital circuitry is partitioned, may be on separate packages, or may be within the same integrated circuit.

In any case, it is necessary to provide isolation between the different supply lines, since the circuit blocks (except one) are not connected to the circuit ground. Therefore, the implementation of the invention within an integrated circuit can advantageously be achieved by using twin-well, triple-well, or silicon-on-insulator process technologies, or physically stacking chip dies, since these process technologies ensure the necessary isolation.

The invention may be of particular applicability in the case of a microprocessor integrated circuit. Such devices often have relatively high power consumption, compared to other components of an electronic product. The present invention can therefore be implemented by dividing the circuitry of the microprocessor into various circuit blocks, which are connected in series between the power supply input pins of the integrated circuit. The integrated circuit can then receive a relatively high supply voltage, which can be generated easily and efficiently, while the individual circuit blocks receive lower supply voltages, which can reduce the total power consumption.

There is therefore disclosed a method which allows reduced supply voltages to be provided for digital circuits in an efficient way.

1. An electronic circuit, comprising a power supply, and a plurality of circuit blocks, wherein the circuit blocks are connected in series with the power supply.

2. An electronic circuit as claimed in claim 1, comprising at least one supply correction circuit, associated with a respective one of the circuit blocks.

3. An electronic circuit as claimed in claim 2, comprising at least one supply correction circuit connected in series with the associated circuit block.

4. An electronic circuit as claimed in claim 3, wherein the at least one supply correction circuit connected in series with the associated circuit block comprises a voltage source.

5. An electronic circuit as claimed in claim 3, wherein the at least one supply correction circuit connected in series with the associated circuit block comprises a voltage sink.

6. An electronic circuit as claimed in claim 3, wherein the at least one supply correction circuit connected in series with the associated circuit block comprises a resistor.

7. An electronic circuit as claimed in claim 3, wherein the at least one supply correction circuit connected in series with the associated circuit block comprises an inductor.

8. An electronic circuit as claimed in claim 3, wherein the at least one supply correction circuit connected in series with the associated circuit block comprises a MOSFET.

9. An electronic circuit as claimed in claim 3, wherein the at least one supply correction circuit connected in series with the associated circuit block comprises a dummy digital circuit.

10. An electronic circuit as claimed in claim 9, further comprising means for changing a degree of activity in the dummy digital circuit.

11. An electronic circuit as claimed in claim 9, further comprising means for changing a clock frequency of the dummy digital circuit.

12. An electronic circuit as claimed in claim 3, wherein the at least one supply correction circuit connected in series with the associated circuit block comprises a switched DC-DC converter.

13. An electronic circuit as claimed in claim 3, further comprising means for detecting a voltage supplied to the associated circuit block, and a feedback circuit for controlling a voltage drop across the supply correction circuit so that said voltage supplied to the associated circuit block reaches a desired value.

14. An electronic circuit as claimed in claim 2, comprising at least one supply correction circuit connected in parallel with the associated circuit block.

15. An electronic circuit as claimed in claim 14, wherein the at least one supply correction circuit connected in parallel with the associated circuit block comprises a current source.

16. An electronic circuit as claimed in claim 14, wherein the at least one supply correction circuit connected in parallel with the associated circuit block comprises a current sink.

17. An electronic circuit as claimed in claim 14, wherein the at least one supply correction circuit connected in parallel with the associated circuit block comprises a resistor.

18. An electronic circuit as claimed in claim 14, wherein the at least one supply correction circuit connected in parallel with the associated circuit block comprises a capacitor.

19. An electronic circuit as claimed in claim 14, wherein the at least one supply correction circuit connected in parallel with the associated circuit block comprises a MOSFET.

20. An electronic circuit as claimed in claim 14, wherein the at least one supply correction circuit connected in parallel with the associated circuit block comprises a dummy digital circuit.

21. An electronic circuit as claimed in claim 20, further comprising means for changing a degree of activity in the dummy digital circuit.

22. An electronic circuit as claimed in claim 20, further comprising means for changing a clock frequency of the dummy digital circuit.

23. An electronic circuit as claimed in claim 14, wherein the at least one supply correction circuit connected in parallel with the associated circuit block comprises a switched DC-DC converter.

24. An electronic circuit as claimed in claim 14, further comprising means for detecting a voltage supplied to the associated circuit block, and a feedback circuit for controlling the current drawn by the supply correction circuit so that said voltage supplied to the associated circuit block reaches a desired value.

25. An electronic circuit as claimed in claim 2, comprising an adjustable supply correction circuit.

26. An electronic circuit as claimed in claim 25, wherein the adjustable supply correction circuit alters its power consumption based on the power consumption of the associated circuit block.

27. An electronic circuit as claimed in claim 25, further comprising means for controlling the adjustable supply correction circuit based on the power consumption of the associated circuit block.

28. An electronic circuit, comprising a power supply producing an available power supply voltage, and a plurality of circuit blocks, wherein the circuit blocks are connected in series with the power supply, such that the available power supply voltage is divided between the circuit blocks.

29. A portable wireless communication device, comprising analog circuitry, a plurality of digital circuit blocks, and a battery power supply providing a power supply voltage,
wherein the battery power supply voltage is provided to the analog circuitry, and
wherein the digital circuit blocks are connected in series across the battery power supply voltage.

30. A microprocessor integrated circuit, having power supply input pins, and comprising a plurality of circuit blocks, which are connected in series between the power supply input pins, such that the integrated circuit can receive a first supply voltage, and the circuit blocks can receive respective second supply voltages lower than the first supply voltage.

31. A method of operating an electronic circuit, comprising defining a plurality of circuit blocks within the circuit, and connecting the circuit blocks in series with a power supply thereto.
